(19) United States
(12) Patent Application Publication
(10) Pub. No.: US 2007/0046574 A1
(43) Pub. Date: Mar. 1, 2007

(54) Plasma display device

(76) Inventors: Takashi Shizaki, Yokohama (JP); Katsuhiro Ishida, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/512,078

(22) Filed: Aug. 30, 2006

(30) Foreign Application Priority Data
Aug. 30, 2005 (JP) JP2005-249565

(51) Int. Cl. G09G 3/28

(52) U.S. Cl. 345/63

(57) ABSTRACT

A plasma display device capable of suppressing the streaking without losing the luminance in an AC plasma display device is provided. In an AC plasma display device in which one screen is comprised of a plurality of sub-fields, and an image is displayed by generating sustain discharges several times between display electrodes in each sub-field, periods where the sustain discharge is generated several times in each sub-field include a plurality of sustain discharge periods with different single sustain discharge currents, for example, a sustain discharge period with small single sustain discharge current and a sustain discharge period with large single sustain discharge current, and a driving circuit, which increases a ratio of the number of sustain discharges in the sustain discharge period with large single sustain discharge current relative to that in the sustain discharge period with small single sustain discharge current, is provided.

### CROSS-REFERENCE TO RELATED APPLICATION

The present application claims priority from Japanese Patent Application No. JP 2005-249565 filed on Aug. 30, 2005, the content of which is hereby incorporated by reference into this application.

### TECHNICAL FIELD OF THE INVENTION

The present invention relates to a technology effectively applied to a driving method of an AC plasma display device used for a display device of a personal computer and a workstation, a flat TV, and a plasma display for displaying advertisements, information, and others.

### BACKGROUND OF THE INVENTION

In AC color plasma display devices, an address/display separation method in which a period when the cells to be displayed are determined (address period) and a display period when discharges for display lighting are performed (sustain discharge period) are separated has been widely employed. In this method, charge is accumulated in the cells, which are to be lit, in the address period, and sustain discharges for display are performed by utilizing the charge in the sustain discharge period.

In the plasma display device, only lighting or not lighting can be selected and the gray level cannot be expressed by the intensity of the discharge. Therefore, in the plasma display device, one display screen (one frame) is divided into a plurality of sub-fields, and the gray level is displayed by combining the sub-fields to be lit for each display cell.

In an example of the configuration of the conventional sub-fields, one frame is divided into n sub-fields. Each sub-field includes a reset period in which all the display cells are brought into a uniform state, an address period in which the cells to be turned on are selected, and a sustain discharge period in which the sustain discharge is generated in the selected display cells to perform the display. In general, luminance of each sub-field is proportional to the number of sustain discharges in the sustain discharge period, and the number of sustain discharges, that is, the luminance is set to a predetermined rate.

In the conventional plasma display device, there is only one type of sustain discharge pulse for generating the sustain discharge, and the sustain discharge pulse of the same waveform is used in each sub-field. In other words, the cycle of the sustain discharge pulse is constant. Therefore, in the sub-fields with different luminance weightings, the length of the sustain discharge period differs. The sustain discharge waveform of the sustain discharge pulse has different luminous efficiency and luminance in one pulse depending on the waveform and the cycle thereof. Meanwhile, the number of sustain discharge pulses in each sub-field (one frame) relates to the number of grayscales to be displayed and the display luminance. Therefore, the sustain discharge waveform, the sub-field configuration, and the number of sustain discharges in each sub-field are determined in comprehensive consideration of these aspects.

Meanwhile, in the plasma display device, the upper limit of the power is set from the relationship of the heat generation and the rated current. The power per one frame relates to the total number of sustain discharges generated in one frame. More specifically, it corresponds to the total value of all sub-fields obtained by summing up the values of respective sub-fields obtained by multiplying the number of cells to be lit in each sub-field by the number of sustain discharge pulses of the sub-field. Accordingly, the power is increased when the bright display is performed on an entire screen and the power is reduced when the dark display is performed on an entire screen. The brightness on the entire one screen (one frame) is called a display load rate, and it can be expressed by the total value of the display grayscale of all display cells in one frame. The power is increased when the frame with large display load rate is displayed and the power is reduced when the frame with small display load rate is displayed.

As described above, although the sub-field configuration is determined in consideration of the number of grayscales to be displayed and the display luminance, the consideration has to be paid also to the upper limit of the power. In order to control the power so as not to exceed the upper limit even when the bright display is performed on an entire screen, the total number of the sustain discharge pulses in one frame has to be set to a small value. In such a case, however, the problem is that the number of grayscales to be displayed and the display luminance are decreased. In general, the occurrence frequency of the bright display on the entire screen is low and the frequency of the successive occurrences thereof is even lower. Therefore, the number of sustain discharge pulses in each sub-field is controlled in accordance with the display load rate so as to perform the display as bright as possible, while maintaining the luminance ratio between sub-fields within a range where the power does not exceed its upper limit. This control is called a sustain discharge number control or a power control.

As described above, although only one type of the sustain discharge pulse is used in general, the method utilizing sustain discharge pulses with different cycles has been proposed. For example, Japanese Patent Application Laid-Open Publication No. 2001-228820 (Patent Document 1) discloses a configuration in which one pulse with short cycle and narrow pulse width and the other pulse with long cycle and wide pulse width are combined to form one unit, and the sustain discharge pulse is repeated with this unit in each sub-field. However, in the configuration disclosed in the Patent Document 1, the ratio of the sustain discharge pulse with a long cycle and the sustain discharge pulse with a short cycle is constant.

### SUMMARY OF THE INVENTION

Incidentally, in the above-described address/display separation method of the AC color plasma display device, when voltage is applied between display electrodes to generate sustain discharge, the phenomenon that the discharge light emission is decreased (streaking) occurs in the display state where the display load in the lateral line is large. This phenomenon is caused due to the voltage drop at the time when current flows to the display electrode with impedance. As means for suppressing the streaking, the reduction of the sustain discharge current is effective. However, the reduction of the sustain discharge current leads to the reduction of the discharge light emission, that is, the reduction of the luminance. Therefore, the luminance and the streaking conflict and are incompatible with each other.

Therefore, an object of the present invention is to provide a plasma display device capable of solving the problems described above and suppressing the streaking without losing the luminance in an AC plasma display device.

The above and other objects and novel characteristics of the present invention will be apparent from the description of this specification and the accompanying drawings.

The typical ones of the inventions disclosed in this application will be briefly described as follows.

The present invention is applied to an AC plasma display device in which one screen is comprised of a plurality of sub-fields and an image is displayed by generating sustain discharge several times between display electrodes in each sub-field and has features as follows.

(1) Periods where the sustain discharge is generated several times in each sub-field include a plurality of sustain discharge periods each having different single sustain discharge currents, and a driving circuit, which increases a ratio of the number of discharges of the sustain discharge period with large single sustain discharge current as the total number of sustain discharges increases, is provided.

(2) According to above (1), the plurality of sustain discharge periods include a sustain discharge period where sustain discharges with small single sustain discharge current are performed and a sustain discharge period where sustain discharges with large single sustain discharge current are performed. The driving circuit increases the ratio of the number of discharges of the sustain discharge period with large single sustain discharge current relative to the sustain discharge period with small single sustain discharge current as the total number of the sustain discharges increases.

(3) According to above (2), a constant N equal to or larger than 1 is set, and when total number of sustain discharges in each of the sub-fields is larger than the constant N, the sustain discharge with small single sustain discharge current is performed N times and the sustain discharge with large single sustain discharge current is performed for rest of the sustain discharges. When total number of sustain discharges in each of the sub-fields is equal to or less than N, only the sustain discharge with small single sustain discharge current is performed. More specifically, when total number of sustain discharges in each of the sub-fields is larger than the constant N, the sustain discharge with large single sustain discharge current is performed while gradually increasing its number of times as the total number of the sustain discharges increases. When total number of sustain discharges in each of the sub-fields is equal to or less than the constant N, the sustain discharge with small single sustain discharge current is performed while gradually reducing its number of times as the total number of the sustain discharges decreases.

(4) According to above (2), a constant M equal to or larger than 1 is set, and when total number of sustain discharges in each of the sub-fields is larger than the constant M, the sustain discharge with small single sustain discharge current is performed while gradually reducing its number of times and the sustain discharge with large single sustain discharge current is performed for rest of sustain discharges while gradually increasing its number of times as the total number of the sustain discharges increases. When total number of sustain discharges in each of the sub-fields is equal to or less than the constant M, the sustain discharge with small single sustain discharge current is performed while gradually reducing its number of times as the total number of the sustain discharges decreases.

(5) According to above (2), a constant L equal to or larger than 1 is set, and when total number of sustain discharges in each of the sub-fields is equal to the constant L, only the sustain discharge with large single sustain discharge current is performed. When total number of sustain discharges in each of the sub-fields is less than the constant L, the sustain discharge with small single sustain discharge current is performed while gradually reducing its number of times as the total number of the sustain discharges decreases.

(6) According to above (1), the driving circuit is provided with an electrical circuit having an LC resonant circuit and a voltage clamp circuit, and a sustain discharge waveform is outputted from the electrical circuit, and by changing a timing of LC resonance by the LC resonant circuit and voltage clamping by the voltage clamp circuit, sustain discharge current by the sustain discharge waveform is changed. When the sustain discharge current is changed, a period from the start of the LC resonance to the voltage clamping is changed. More specifically, when the sustain discharge current is small, the period from the start of the LC resonance to the voltage clamping is set to a first time width, and when the sustain discharge current is large, the period from the start of the LC resonance to the voltage clamping is set to a second time width shorter than the first time width.

The effects obtained by typical aspects of the present invention will be briefly described below.

According to the present invention, it is possible to suppress the streaking without losing the luminance in an AC plasma display device.

### BRIEF DESCRIPTIONS OF THE DRAWINGS

FIG. 1 is a diagram showing an example of the entire structure of the plasma display device according to an embodiment of the present invention;

FIG. 2 is an exploded perspective view showing an example of a plasma display panel in the plasma display device according to an embodiment of the present invention;

FIG. 3A is a diagram showing an example of a sub-field configuration in one frame in the plasma display device according to an embodiment of the present invention;

FIG. 3B is a diagram showing an example of a state change of each sub-field in the plasma display device according to an embodiment of the present invention;

FIG. 4A is a diagram showing an example of the relationship of the number of sustain discharges to display load in the driving method of the plasma display device according to the first embodiment of the present invention;

FIG. 4B is a diagram showing an example of the relationship of the ratio of the sustain discharge A to the display load in the driving method of the plasma display device according to the first embodiment of the present invention;

FIG. 5 is a diagram showing an example of an electrical circuit for outputting the sustain discharge waveform in the driving method of the plasma display device according to the first embodiment of the present invention;

FIG. 6A is a diagram showing an example of the sustain discharge waveform with small discharge current outputted from the electrical circuit shown in FIG. 5 in the driving method of the plasma display device according to the first embodiment of the present invention;

FIG. 6B is a diagram showing an example of the sustain discharge waveform with middle discharge current outputted from the electrical circuit shown in FIG. 5 in the driving method of the plasma display device according to the first embodiment of the present invention;

FIG. 6C is a diagram showing an example of the sustain discharge waveform with large discharge current outputted from the electrical circuit shown in FIG. 5 in the driving method of the plasma display device according to the first embodiment of the present invention;

FIG. 7A is a diagram showing an example of the relationship of the number of sustain discharges to display load in the driving method of the plasma display device according to the second embodiment of the present invention;

FIG. 7B is a diagram showing an example of the relationship of the ratio of the sustain discharge A to the display load in the driving method of the plasma display device according to the second embodiment of the present invention;

FIG. 8A is a diagram showing an example of the relationship of the number of sustain discharges to display load in the driving method of the plasma display device according to the third embodiment of the present invention;

FIG. 8B is a diagram showing an example of the relationship of the ratio of the sustain discharge A to the display load in the driving method of the plasma display device according to the third embodiment of the present invention;

FIG. 9A is a diagram showing an example of the number of sustain discharges in each sub-field in the case where the display load is large in the driving method of the plasma display device according to the third embodiment of the present invention;

FIG. 9B is a diagram showing an example of the number of sustain discharges in each sub-field in the case where the display load is small in the driving method of the plasma display device according to the third embodiment of the present invention; and

FIG. 10 is a diagram showing an example of the sub-field configuration in which two types of sustain discharges are mixed in the driving method of the plasma display device according to the third embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### Concept of the Embodiments of the Present Invention

In an AC plasma display device, the discharge light emission is reduced when the discharge current is decreased as described above. However, it does not cause any problem when the display load is sufficiently large. This is because, when the display load is large, the total amount of discharge light emission is restricted by the inputted power. When the discharge current is decreased, the amount of single discharge light emission is reduced. However, since the number of discharges is increased, the luminance is determined by the product of the discharge current and the number of discharges, that is, the inputted power. The problem occurs in the display state with small display load, that is, the state where the inputted power does not exceed a set value even when the number of discharges reaches the maximum. In this case, since the number of discharges is the maximum value in the driving operation, the luminance is proportional to the single discharge current.

Meanwhile, the streaking particularly causes a problem when the display load is large. This is because the voltage drop in the display electrode becomes significant when the display load is large. On the other hand, since the voltage drop is small when the display load is small, the problem does not occur in the display.

As described above, the problem in luminance occurs when the display load is small and the problem in streaking occurs when the display load is large.

Therefore, the control to increase the discharge current when the display load is small and to decrease the discharge current when the display load is large is the effective means for simultaneously achieving the high luminance and the suppression of the streaking.

More specifically, a sustain discharge waveform with large discharge current and a sustain discharge waveform with small discharge current are prepared, and a ratio of the sustain discharge waveform with large discharge current is increased when the display load is small and a ratio of the sustain discharge waveform with small discharge current is increased when the display load is large.

Based on the concept of the embodiments of the present invention as described above, the embodiments of the present invention including the description for a plasma display device, a plasma display panel, and the configuration of sub-fields will be described below in detail.

### Structure of Plasma Display Device

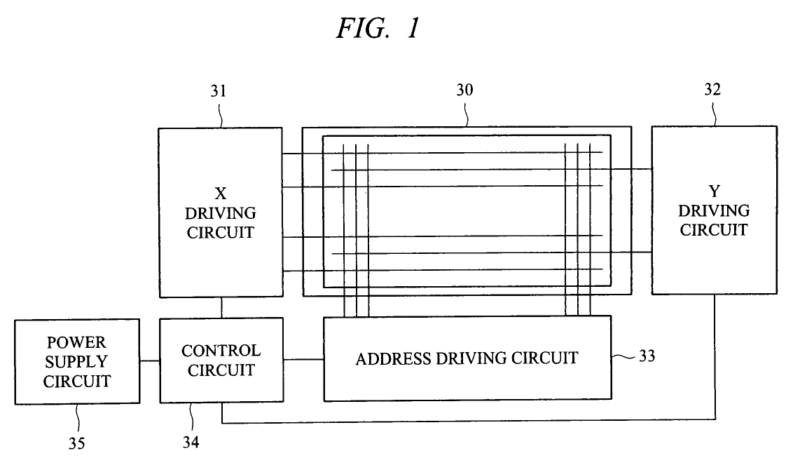

FIG. 1 is a diagram showing an example of the entire structure of the plasma display device according to an embodiment of the present invention. The plasma display device in this embodiment is not limited to this, and an example where the present invention is applied to an ALIS type AC plasma display device is shown here. As shown in FIG. 1, the plasma display device is composed of a plasma display panel 30, an X driving circuit 31, a Y driving circuit 32, an address driving circuit 33, a control circuit 34, a power supply circuit 35 and others.

The plasma display panel 30 includes: display electrodes extending in a lateral direction (longitudinal direction) which are divided into an X electrode group and a Y electrode group; and an address electrode group extending in a vertical direction. The X electrodes and the Y electrodes are alternately arranged and the number of X electrodes is one larger than that of the Y electrodes. The X electrode group is connected to the X driving circuit 31. Also, the X electrodes are divided into odd-numbered X electrodes and even-numbered X electrodes, and the odd-numbered X electrode group and the even-numbered X electrode group are respectively driven in common. The Y electrode group is connected to the Y driving circuit 32. Also, scan pulses are sequentially applied to the Y electrodes, and when the scan pulse is not applied, the Y electrodes are divided into odd-numbered Y electrodes and even-numbered Y electrodes, and the odd-numbered Y electrode group and the even-numbered Y electrode group are respectively driven in common. The address electrode group is connected to the address driving circuit 33, and address pulses are independently applied thereto in synchronization with the scan pulse. The X, Y and address driving circuits 31 to 33 are controlled by the control circuit 34, and power is supplied to each circuit from the power supply circuit 35.

### Structure of Plasma Display Panel

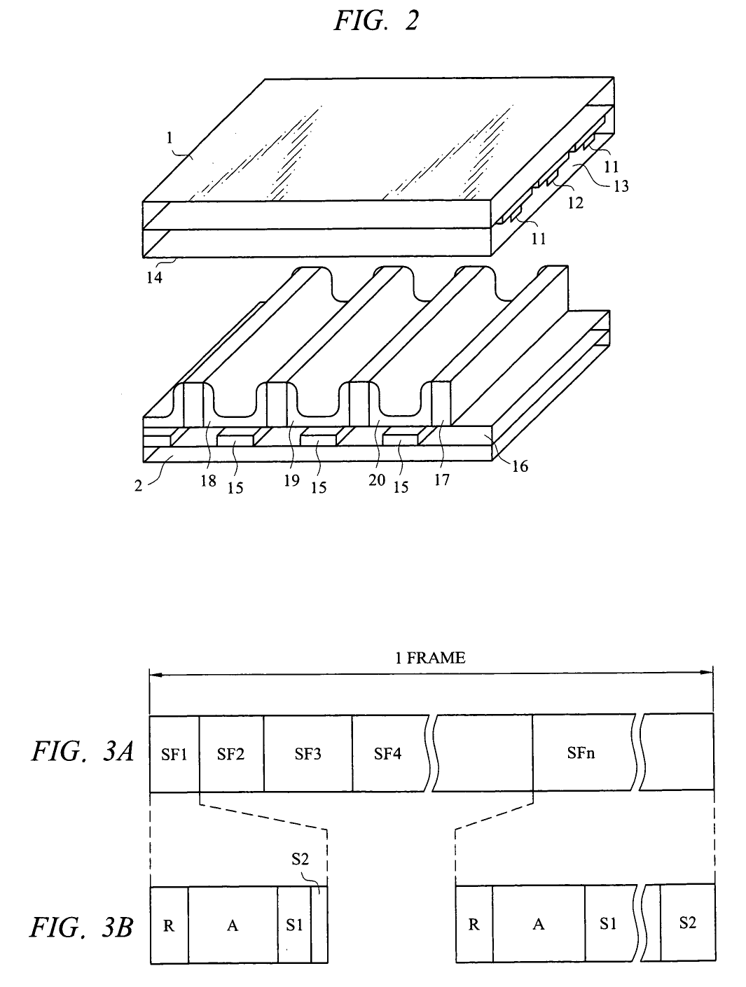

FIG. 2 is an exploded perspective view showing an example of a plasma display panel. The plasma display panel 30 is composed of a front substrate 1, a rear substrate 2, and others as shown in FIG. 2.

The X electrodes 11 and the Y electrodes 12 extending in a lateral direction are alternately arranged in parallel on the front substrate 1. These X electrodes 11 and the Y electrodes 12 are covered with a dielectric layer 13, and a surface of the dielectric layer 13 is covered with a protective layer 14 such as MgO. The address electrodes 15 extending in a direction almost vertical to the X electrodes 11 and the Y electrodes 12 are arranged on the rear substrate 2, and the address electrodes 15 are covered with a dielectric layer 16. Barrier ribs 17 are arranged on both sides of the address electrode 15 and the barrier ribs 17 separate the cells in a column direction. Further, phosphors 18, 19, and 20 which are excited by ultraviolet radiation to generate visible lights of red (R), green (G), and blue (B) are coated on the dielectric layer 16 on the address electrodes 15 and on the side surfaces of the barrier ribs 17. The front substrate 1 and the rear substrate 2 are bonded to each other so that the protective layer 14 and the barrier ribs 17 are in contact with each other and discharge gas such as Ne or Xe is filled therebetween. In this manner, the plasma display panel 30 is formed.

In the structure of the plasma display panel 30 described above, the Y electrode 12 selectively performs the sustain discharge with the X electrode 11 on one side in an odd-number field and selectively performs the sustain discharge with the X electrode 11 on the other side in an even-number field. Therefore, in the ALIS type plasma display device shown in FIG. 1 and FIG. 2, the interlace display is performed, and display lines are formed between all of the X electrodes 11 and the Y electrodes 12.

### Configuration of Sub-Fields

FIG. 3 is a diagram showing an example of the sub-field configuration in one frame (FIG. 3A) and a state change of each sub-field (FIG. 3B). As shown in FIG. 3A, one frame is divided into n sub-fields SF1 to SFn. Each of the sub-fields has a reset period R in which all the display cells are brought into a uniform state, an address period A in which the display cells to be turned on are selected, and a sustain discharge period S in which the sustain discharge is generated in the selected display cells to perform the display.

In this embodiment, the sustain discharge period S of each of the sub-fields SF1 to SFn includes a period Si in which a first sustain discharge waveform is used and a period S2 in which a second sustain discharge waveform is used, and the ratio of the period Si and the period S2 is changed. FIG. 3B shows the state where both of the first sustain discharge waveform and the second sustain discharge waveform are used in each sub-field. More specifically, the sustain discharge waveform with large discharge current and the sustain discharge waveform with small discharge current are prepared, and the ratio of the sustain discharge waveform with large discharge current is increased when the display load is small and the ratio of the sustain discharge waveform with small discharge current is increased when the display load is large.

### First Embodiment

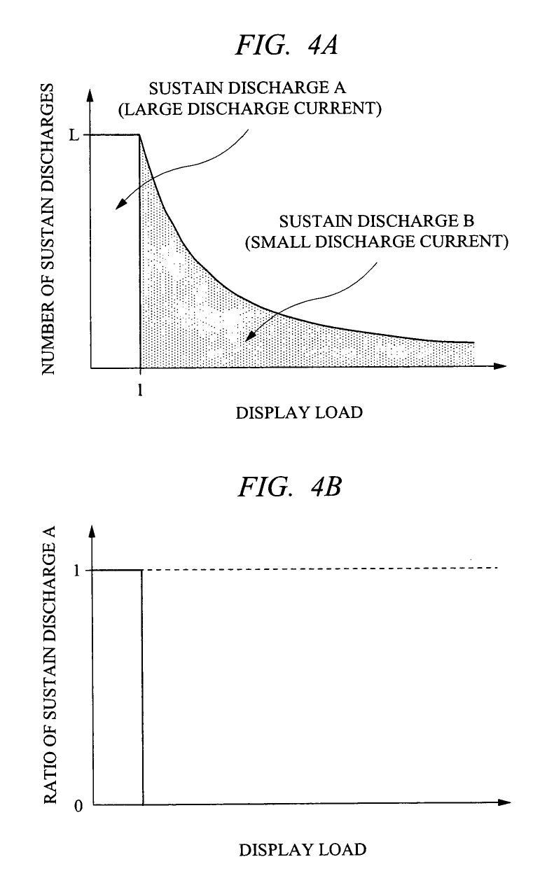

A driving method of a plasma display device according to the first embodiment will be described with reference to FIG. 4 to FIG. 6.

In the driving method of a plasma display device according to the first embodiment, a constant L equal to or larger than 1 is set, and when the total number of sustain discharges in each sub-field is equal to the constant L, only the sustain discharge with large single sustain discharge current is performed, and when the total number of sustain discharges in each sub-field is less than the constant L, only the sustain discharge with small single sustain discharge current is performed, while gradually reducing its number of times as the total number of sustain discharges decreases.

FIG. 4 is a diagram showing an example of the relationship of the number of sustain discharges to display load (FIG. 4A) and the relationship of the ratio of the sustain discharge A to the display load (FIG. 4B) in the driving method of a plasma display device according to the first embodiment.

In the driving method of this embodiment, as shown in FIG. 4A, when the display load is equal to or lower the display load (1) determined based on the number of sustain discharges (L), the driving waveform with large discharge current (sustain discharge A) is applied in all sustain discharges, and when the display load is larger than the display load (1) where the number of sustain discharges starts to decrease, the driving waveform with small discharge current (sustain discharge B) is applied in all sustain discharges. When this driving method is seen from the viewpoint of the ratio of the sustain discharge A, as shown in FIG. 4B, when the display load is equal to or lower than (1), the ratio of the sustain discharge A is 1, and when the display load is larger than (1), the ratio of the sustain discharge A is 0.

As described above, when the display load is small, the ratio of the sustain discharge waveform with large discharge current is increased, and when the display load is large, the ratio of the sustain discharge waveform with small discharge current is increased. By this means, the high luminance and the suppression of the streaking can be simultaneously achieved.

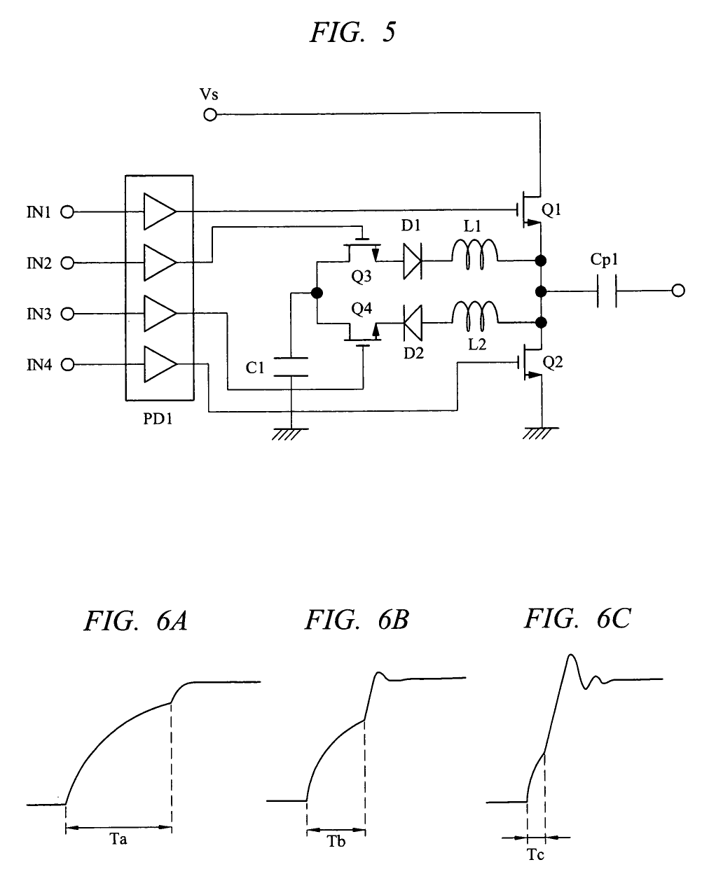

FIG. 5 is a diagram showing an example of an electrical circuit for outputting the sustain discharge waveform. This electrical circuit is included in the X driving circuit 31 and the Y driving circuit 32 for driving the X electrodes 11 and the Y electrodes 12 of the plasma display panel 30, and it is composed of an LC resonant circuit, a voltage clamp circuit, and others. The LC resonant circuit is composed of coils L1 and L2 which resonate with the capacitor Cp1 of the plasma display panel, diodes D1 and D2, transistors Q3 and Q4, a capacitor C1 and others. The voltage clamp circuit is composed of transistors Q1 and Q2 and others. These transistors Q1 to Q4 are driven by a drive circuit PD1 to which input signals IN1 to IN4 are inputted.

FIG. 6 is a diagram showing examples of the sustain discharge driving waveform outputted from the electrical circuit shown in FIG. 5, in which FIG. 6A shows the waveform in the case of small discharge current, FIG. 6B shows the waveform in the case of middle discharge current, and FIG. 6C shows the waveform in the case of large discharge current.

In general, the sustain discharge waveform is provided by applying a certain voltage in the LC resonant circuit and then setting it to a predetermined voltage in the voltage clamp circuit in the electrical circuit shown in FIG. 5. At this time, the amount of discharge current can be changed based on the period from the start of the LC resonance to the voltage clamping. When the amount of discharge current is large, the time width from the start of the LC resonance to the voltage clamping is shortened in comparison with the case where the amount of discharge current is small. In FIG. 6, the timing of starting the voltage clamping is hastened in FIG. 6C than FIG. 6B and is hastened in FIG. 6B than FIG. 6A, and the amount of discharge current is larger in FIG. 6C than FIG. 6B and is larger in FIG. 6B than FIG. 6A.

For example, in the sustain discharge waveform in FIG. 6A, first, the transistor Q3 is turned on to start the LC resonance, thereby increasing the voltage. Then, after the elapse of time Ta, the transistor Q1 is turned on to clamp the voltage, thereby fixing the voltage to the power supply Vs. Also, the sustain discharge waveform of FIG. 6B can be provided by hastening the timing to turn on the transistor Q1 than FIG. 6A (time Th), and the sustain discharge waveform of FIG. 6C can be provided by further fastening the timing (time Tc).

The sustain discharge waveforms shown in FIG. 6A to FIG. 6C are applied from the X driving circuit 31 to the X electrodes 11 of the plasma display panel 30. In this case, though not illustrated, the sustain discharge waveforms with the polarity reverse to those of FIG. 6A to FIG. 6C are applied to the Y electrodes 12 from the Y driving circuit 32. The sustain discharge waveform of the reverse polarity can be provided in the following manner. That is, the transistor Q4 is turned on to start the LC resonance, and after the elapse of a predetermined time, the transistor Q2 is turned on to fix the voltage to the power supply GND. Note that, when these waveforms are applied to FIG. 4, the sustain discharge waveforms shown in FIG. 6A and FIG. 6C are applied among from the sustain discharge waveforms of FIG. 6A to FIG. 6C. However, it is needless to say that any combinations of the sustain discharge waveforms can be applied as long as there is a difference in discharge current intensity, for example, the combination of those of FIG. 6A and FIG. 6B and the combination of those of FIG. 6B and FIG. 6C.

### Second Embodiment

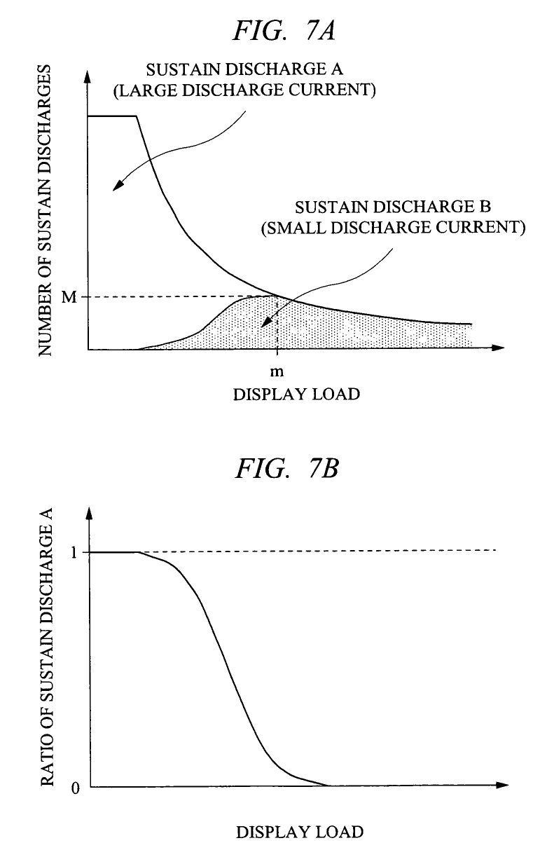

A driving method of a plasma display device according to the second embodiment will be described with reference to FIG. 7.

In the first embodiment, the waveform with large discharge current and the waveform with small discharge current are switched at a certain display load. Therefore, if the luminance of the sustain discharge A is significantly different from the luminance of the sustain discharge B in FIG. 4A, the luminance becomes discontinuous between before and after the switching. The second embodiment is intended to solve this problem.

In the driving method of the plasma display device according to the second embodiment, a constant M equal to or larger than 1 is set, and when the total number of sustain discharges in each sub-field is larger than M, the sustain discharge with small single sustain discharge current is performed while gradually reducing its number of times and the sustain discharge with large single sustain discharge current is performed for the rest of discharges while gradually increasing its number of times as the total number of sustain discharges increases. Also, when the total number of sustain discharges in each sub-field is equal to or smaller than M, only the sustain discharge with small single sustain discharge current is performed while gradually reducing its number of times as the total number of sustain discharges decreases.

FIG. 7 is a diagram showing an example of the relationship of the number of sustain discharges to display load (FIG. 7A) and the relationship of the ratio of the sustain discharge A to the display load (FIG. 7B) in the driving method of a plasma display device according to the second embodiment.

In the driving method of this embodiment, as shown in FIG. 7A, when the display load is within the range between the display load (m) determined based on the number of sustain discharges (M) and that where the number of sustain discharges starts to decrease, both of the driving waveform with large discharge current (sustain discharge A) and the driving waveform with small discharge current (sustain discharge B) are applied. When this driving method is seen from the viewpoint of the ratio of the sustain discharge A, as shown in FIG. 7B, when the display load is equal to (m) or lower, the ratio of the sustain discharge A and the sustain discharge B is gradually changed.

In this manner, the effect similar to that of the first embodiment can be achieved and the problem of the discontinuity of the luminance caused in the first embodiment can be solved.

### Third Embodiment

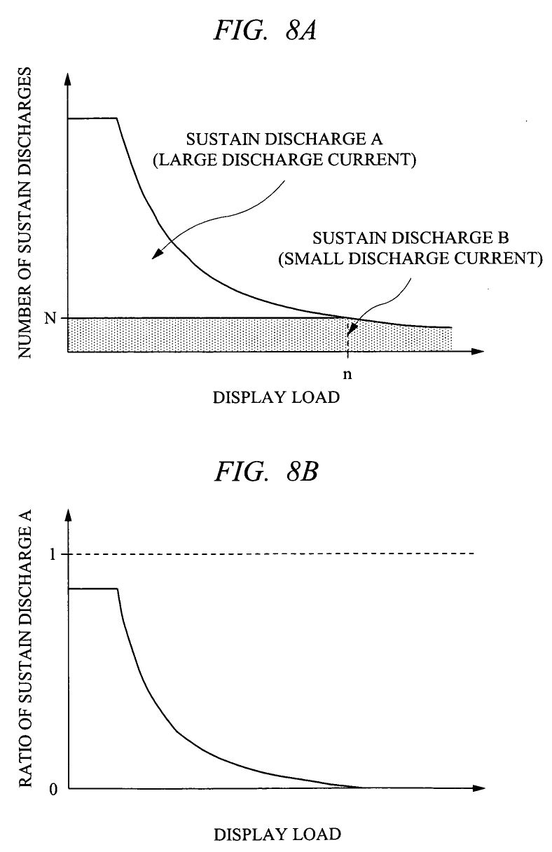

A driving method of a plasma display device according to the third embodiment will be described with reference to FIG. 8 to FIG. 10.

In the driving method of the plasma display device according to the third embodiment, a constant N equal to or larger than 1 is set, and when the total number of sustain discharges in each sub-field is larger than N, the sustain discharge with small single sustain discharge current is performed N times and the sustain discharge with large single sustain discharge current is performed for the rest of sustain discharges. Also, when the total number of sustain discharges in each sub-field is equal to or smaller than N, only the sustain discharge with small single sustain discharge current is performed.

More specifically, when the total number of sustain discharges in each sub-field is larger than the constant N, the sustain discharge with large single sustain discharge current is performed while gradually increasing its number of times as the total number of sustain discharges increases, and when the total number of sustain discharges in each sub-field is equal to or smaller than the constant N, only the sustain discharge with small single sustain discharge current is performed while gradually reducing its number of times as the total number of sustain discharges decreases.

FIG. 8 is a diagram showing an example of the relationship of the number of sustain discharges to display load (FIG. 8A) and the relationship of the ratio of the sustain discharge A to the display load (FIG. 8B) in the driving method of a plasma display device according to the third embodiment.

In the driving method of this embodiment, as shown in FIG. 8A, when the display load is lower than the display load (n) determined based on the number of sustain discharges (N), the driving waveform with large discharge current (sustain discharge A) is applied, and the driving waveform with small discharge current (sustain discharge B) is also applied N times. When this driving method is seen from the viewpoint of the ratio of the sustain discharge A, as shown in FIG. 8B, when the display load is lower than (n), the ratio of the sustain discharge A and the sustain discharge B is gradually changed.

In this manner, the effect similar to those of the first and second embodiments can be achieved, and since the number of sustain discharges B is limited by a certain constant, the control for changing the ratio between the sustain discharge A and the sustain discharge B can be facilitated in comparison to the second embodiment. For example, in the second embodiment, a numerical table in which the ratio between the sustain discharge A and the sustain discharge B is described and an arithmetic process are necessary. Meanwhile, in this embodiment, this control can be made by only setting a certain constant.

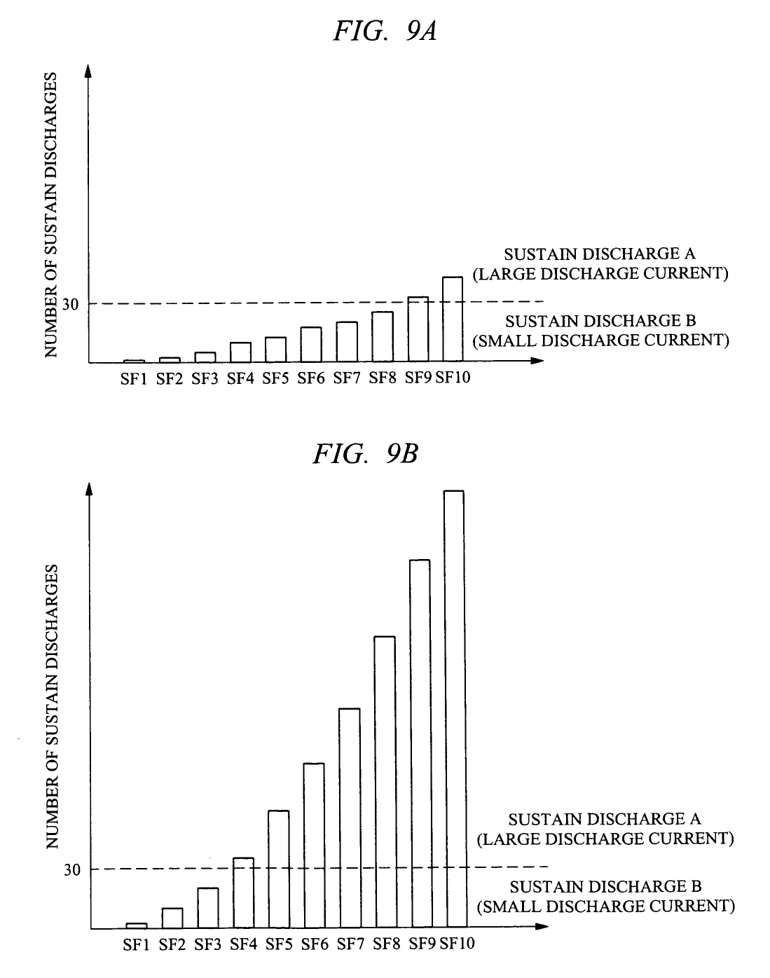

FIG. 9 is a diagram showing an example of the number of sustain discharges in each sub-field in the cases where the display load is large (FIG. 9A) and the display load is small (FIG. 9B). In an example where sub-fields SF1 to SF10 are provided, when the display load is large, most of the discharges are sustain discharges B (small discharge current) as shown in FIG. 9A and the display nonuniformity and the streaking are close to those of the case where only the sustain discharge B is used. When display load is small, most of the discharges are sustain discharges A (large discharge current), and the peak luminance is close to that of the case where only the sustain discharge A is used.

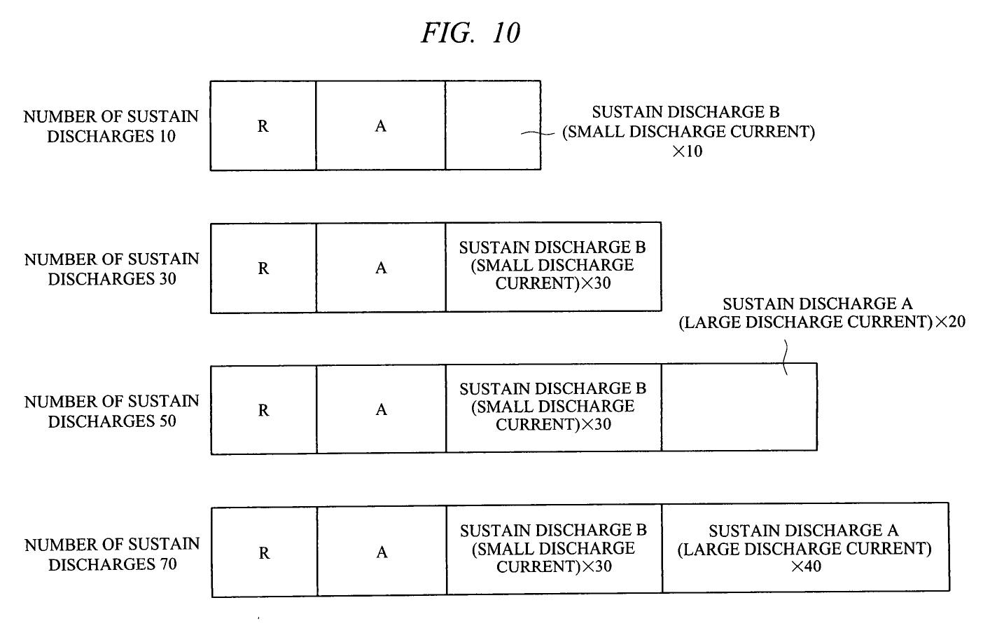

FIG. 10 is a diagram showing an example of the sub-field configuration in which two types of sustain discharges are mixed. For example, in the case where the number of sustain discharges are set to 10 times, 30 times, 50 times and 70 times, only the sustain discharge B is performed for the sub-field with the number of sustain discharges of 30 times or less, and the sustain discharge B is performed 30 times and the sustain discharge A is performed for the rest of discharges for the sub-field with the number of sustain discharges of more than 30 times.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be applied to a technology for driving an A/C plasma display device used for a display device of a personal computer and a workstation, a flat TV, and a plasma display for displaying advertisements, information, and others.

What is claimed is:

1. A plasma display device, which is an AC plasma display device in which one screen is comprised of a plurality of sub-fields, and an image is displayed by generating sustain discharge several times between display electrodes in each sub-field,
wherein periods where the sustain discharge is generated several times in each sub-field include a plurality of sustain discharge periods each having different single sustain discharge currents, and
a driving circuit, which increases a ratio of the number of discharges of the sustain discharge period with large single sustain discharge current as the total number of sustain discharges increases, is provided.

2. The plasma display device according to claim 1,
wherein said plurality of sustain discharge periods include a sustain discharge period where sustain discharges with small single sustain discharge current are performed and a sustain discharge period where sustain discharges with large single sustain discharge current are performed, and
said driving circuit increases the ratio of the number of discharges of the sustain discharge period with large single sustain discharge current relative to the sustain discharge period with small single sustain discharge current as the total number of said sustain discharges increases.

3. The plasma display device according to claim 2,
wherein a constant N equal to or larger than 1 is set,
when total number of sustain discharges in each of said sub-fields is larger than said constant N, said sustain discharge with small single sustain discharge current is performed N times and said sustain discharge with large single sustain discharge current is performed for rest of the sustain discharges, and
when total number of sustain discharges in each of said sub-fields is equal to or less than N, only the sustain discharge with small single sustain discharge current is performed.

4. The plasma display device according to claim 3,
wherein, when total number of sustain discharges in each of said sub-fields is larger than said constant N, said sustain discharge with large single sustain discharge current is performed while gradually increasing its number of times as the total number of said sustain discharges increases, and
when total number of sustain discharges in each of said sub-fields is equal to or less than said constant N, said sustain discharge with small single sustain discharge current is performed while gradually reducing its number of times as the total number of said sustain discharges decreases.

5. The plasma display device according to claim 2,
wherein a constant M equal to or larger than 1 is set,
when total number of sustain discharges in each of said sub-fields is larger than said constant M, said sustain discharge with small single sustain discharge current is performed while gradually reducing its number of times and said sustain discharge with large single sustain discharge current is performed for rest of sustain discharges while gradually increasing its number of times as the total number of said sustain discharges increases, and
when total number of sustain discharges in each of said sub-fields is equal to or less than said constant M, said sustain discharge with small single sustain discharge current is performed while gradually reducing its number of times as the total number of said sustain discharges decreases.

6. The plasma display device according to claim 2,
wherein a constant L equal to or larger than 1 is set, when total number of sustain discharges in each of said sub-fields is equal to said constant L, only said sustain discharge with large single sustain discharge current is performed, and
when total number of sustain discharges in each of said sub-fields is less than said constant L, said sustain discharge with small single sustain discharge current is performed while gradually reducing its number of times as the total number of said sustain discharges decreases.

7. The plasma display device according to claim 1,
wherein said driving circuit is provided with an electrical circuit having an LC resonant circuit and a voltage clamp circuit, and a sustain discharge waveform is outputted from said electrical circuit, and
by changing a timing of LC resonance by said LC resonant circuit and voltage clamping by said voltage clamp circuit, sustain discharge current by said sustain discharge waveform is changed.

8. The plasma display device according to claim 7,
wherein, when said sustain discharge current is changed, a period from the start of said LC resonance to said voltage clamping is changed.

9. The plasma display device according to claim 8,
wherein, when said sustain discharge current is small, said period from the start of said LC resonance to said voltage clamping is set to a first time width, and
when said sustain discharge current is large, said period from the start of said LC resonance to said voltage clamping is set to a second time width shorter than said first time width.
